(19) United States
(12) Patent Application Publication
(10) Pub. No.: US 2013/0059204 A1
(43) Pub. Date: Mar. 7, 2013

(54) ELECTRODE FOR A SECONDARY LITHIUM-ION BATTERY

(71) Applicants: Michael Holzapfel, Freising (DE); Nicolas Tran, Nandlstadt (DE)

(72) Inventors: Michael Holzapfel, Freising (DE); Nicolas Tran, Nandlstadt (DE)

(73) Assignee: Sued-Chemie IP GmbH & Co., KG, Munich (DE)

(21) Appl. No.: 13/575,708

(22) PCT Filed: Jan. 28, 2011
(86) PCT No.: PCT/EP11/51195

§ 371 Date: Nov. 12, 2012

(30) Foreign Application Priority Data
Jan. 28, 2010 (DE) 10 2010 006 076.3

(51) Int. Cl. H01M 4/485; C01D 15/02; H01M 4/58; H01M 4/583

(52) U.S. Cl. 429/231.1; 429/231.95; 429/231.8; 423/594.15; 252/182.1

(57) ABSTRACT

An electrode, free of added conductive agent, for a secondary lithium-ion battery with a lithium-metal-oxygen compound as active material, and a secondary lithium-ion battery which contains the electrode.

### CROSS-REFERENCE TO RELATED APPLICATIONS

This application is a U.S. National Stage application claiming benefit of International Application No. PCT/EP2011/051195, filed Jan. 28, 2011, and claiming benefit of German Application No. DE 10 2010 006 076.3, filed Jan. 28, 2010. The entire disclosures of both PCT/EP2011/051195 and DE 10 2010 006 076.3 are incorporated herein by reference.

### BACKGROUND

The present invention relates to an electrode, free of added conductive agent, for a secondary lithium-ion battery with a lithium-metal-oxygen compound as active material and to a secondary lithium-ion battery which contains an electrode according to the invention.

The field of rechargeable lithium-ion batteries (secondary lithium-ion batteries) has been the subject of extremely intensive research for some time, in particular with regard to the replacement of conventional types of drive (spark-ignition and diesel engines) with electric motors, as well as through the use of lithium-ion batteries in computers, mobile telephones and electrically powered tools.

Interest centres in particular on new materials for cathodes and anodes of such lithium-ion batteries—in addition to new electrolyte materials.

Thus the use of lithium titanate Li₄Ti₅O₁₂, or lithium titanium spinel for short, as a substitute for graphite as anode material in rechargeable lithium-ion batteries has been proposed for some time.

A current overview of anode materials in such batteries can be found e.g. in Bruce et al., Angew. Chem. Int. Ed. 2008, 47, 2930-2946.

The advantages of Li₄Ti₅O₁₂ compared with graphite are in particular its better cycle stability, its better thermal load capacity as well as the higher operational reliability.

Li₄Ti₅O₁₂ has a relatively constant potential difference of 1.55 V compared with lithium and achieves several 1000 charge and discharge cycles with a loss of capacity of only <20%.

Thus lithium titanate displays a clearly more positive potential than graphite, which has previously customarily been used as anode in rechargeable lithium-ion batteries.

However, the higher potential also results in a smaller voltage difference. Together with a reduced capacity of 175 mAh/g compared with 372 mAh/g (theoretical value) of graphite, this leads to a clearly lower energy density compared with lithium-ion batteries with graphite anodes.

Moreover, Li₄Ti₅O₁₂ has a long life and is non-toxic and is therefore also not to be classified as posing a threat to the environment.

The material density of lithium titanium spinel is comparatively low (3.5 g/cm³) compared with e.g. lithium manganese spinel or lithium cobalt oxide (4 and 5 g/cm³ respectively), which are used as cathode materials.

However, lithium titanium spinel (containing Ti⁴⁺ exclusively) is an electronic insulator, which is why a conductive additive (conductive agent), such as e.g. acetylene black, carbon black, ketjen black, etc., always needs to be added to electrode compositions of the state of the art in order to guarantee the necessary electronic conductivity of the electrode. The energy density of batteries with lithium titanium spinel anodes thereby falls. However, it is also known that lithium titanium spinel in the reduced state (in its “charged” form, containing Ti³⁺ and Ti^{a+}) becomes an almost metallic conductor, whereby the electronic conductivity of the whole electrode would have to clearly increase.

In the field of cathode materials, doped or undoped LiFePO₄ has recently preferably been used as cathode material in lithium-ion batteries, with the result that e.g. a voltage difference of 2 V can be achieved in a combination of Li₄Ti₅O₁₂ and LiFePO₄.

The non-doped or doped mixed lithium transition metal phosphates with ordered or modified olivine structure or else NASICON structure, such as LiFePO₄, LiMnPO₄, LiCoPO₄, LiMn₁₋ₓFeₓPO₄, Li₃Fe₂(PO₄)₃ were first proposed as cathode material in electrodes of secondary lithium-ion batteries by Goodenough et al. (U.S. Pat. No. 5,910,382, U.S. Pat. No. 6,514,640). These materials, in particular LiFePO₄, are also actually poorly to not at all conductive materials. Furthermore the corresponding vanadates have also been investigated.

An added conductive agent as already described in more detail above must therefore always be added to the doped or non-doped lithium transition metal phosphate or vanadate, as is the case with the above-mentioned lithium titanate as well, before the latter can be processed to cathode formulations. Alternatively, lithium transition metal phosphate or vanadate as well as lithium titanium spinel carbon composite materials are proposed which, however, because of their low carbon content, also always require the addition of a conductive agent. Thus EP 1 193 784, EP 1 193 785 as well as EP 1 193 786 describe so-called carbon composite materials of LiFePO₄ and amorphous carbon which, when producing iron phosphate from iron sulphate, sodium hydrogen phosphate, also serves as reductant for residual Fe³⁺ radicals in the iron sulphate as well as to prevent the oxidation of Fe²⁺ to Fe³⁺. The addition of carbon is also intended to increase the conductivity of the lithium iron phosphate active material in the cathode. Thus in particular EP 1 193 786 indicates that not less than 3 wt.-% carbon must be contained in the lithium iron phosphate carbon composite material in order to achieve the necessary capacity and corresponding cycle characteristics which are necessary for an electrode that functions well.

To produce the above-named anode and cathode materials, in particular lithium titanium spinel and the lithium transition metal phosphates, both solid-state syntheses and so-called hydrothermal syntheses from aqueous solution are proposed. Meanwhile, almost all metal and transition metal cations are known from the state of the art as doping cations.

### SUMMARY

The object of the present invention was thus to provide further electrodes with an increased specific energy density (Wh/kg or Wh/l) and with a higher load capacity for rechargeable lithium-ion batteries.

This object is achieved by an electrode, free of added conductive agent, with a lithium-metal-oxygen compound as active material.

It was unexpectedly found that the addition of conductive agents, such as carbon black, acetylene black, ketjen black, graphite, etc., to the formulation of an electrode according to the invention can be entirely dispensed with, without its operability being adversely affected. This was all the more surprising because, as stated above, both the lithium titanium spinels and the lithium transition metal phosphates or vanadates are typically insulators or electrically very poorly conductive.

However, by “free of added conductive agent” is also meant here that there may be small quantities of carbon in the electrode formulation, e.g. without being thereby limited, through a carbon-containing coating or in the form of a lithium titanium carbon composite material within the meaning of EP 1 193 784 A1 or as carbon particles, but these do not exceed a proportion of at most 1.5 wt.-%, preferably at most 1 wt.-%, still more preferably at most 0.5 wt.-% carbon relative to the active material of the electrodes.

Compared with electrodes of the state of the art with typically 3-20% added conductive agent, with the electrode free of added conductive agent according to the invention, an increase in the electrode density (measured in g/cm³) is obtained. Thus, compared with electrodes with added conductive agent, e.g. an increase in the electrode density of typically more than 10%, preferably more than 15% and still more preferably more than 25%, was measured.

This increase in the electrode density leads to a higher volumetric capacity even with a low charge/discharge rate of electrodes according to the invention.

Through the higher density of the active material, electrodes without added conductive agent with a higher specific power (W/kg or W/l) and also specific energy density (Wh/kg or Wh/l) than electrodes with added conductive agent are thus further obtained.

The electrode according to the invention further contains a binder. Any binder known per se to a person skilled in the art may be used as binder, such as for example polytetrafluoroethylene (PTFE), polyvinylidene difluoride (PVDF), polyvinylidene difluoride hexafluoropropylene copolymers (PVDF-HFP), ethylene-propylene-diene terpolymers (EPDM), tetrafluoroethylene hexafluoropropylene copolymers, polyethylene oxides (PEO), polyacrylonitriles (PAN), polymethyl methacrylates (PMMA), carboxymethylcelluloses (CMC), and derivatives and mixtures thereof.

The electrode preferably has a proportion of active material of ≧94 wt.-%, still more preferably of ≧96 wt.-%. Even at these high levels of active matter in the electrode according to the invention, its operability is not restricted.

The active material is preferably selected from the group consisting of doped or non-doped lithium titanates (with spinel structure), lithium metal phosphates and lithium metal vanadates (the last two compound classes both with ordered and modified olivine structure and with NASICON structure).

In advantageous developments of the present invention, the particles of the active material have a carbon coating. This is applied e.g. as described in EP 1 049 182 B1. Further coating methods are known to a person skilled in the art. The proportion of carbon in the whole electrode is, in this specific embodiment, ≦1.5 wt.-%, thus clearly below the value named in the state of the art cited above and previously considered necessary.

In a preferred embodiment, therefore, the active material is a doped or non-doped lithium titanate, wherein this electrode functions as anode.

The term “lithium titanate” or “lithium titanium spinel” here refers generally to both the non-doped and the doped forms.

It includes all lithium titanium spinels of the Li₁₋ₓTi₂₋ₓO₄ type with 0≦x≦1/3 of the space group Fd3m and in general also all mixed lithium titanium oxides of the generic formula LiₓTi_{y}O (0<x, y<1).

Quite particularly preferably, the lithium titanate used according to the invention is phase-pure. By “phase-pure” or “phase-pure lithium titanate” is meant according to the invention that no rutile phase can be detected in the end-product by means of XRD measurements within the limits of the usual measurement accuracy. In other words, the lithium titanate according to the invention is rutile-free in this preferred embodiment.

In preferred developments of the invention, the lithium titanate according to the invention is, as already stated, doped with at least one further metal, which leads to a further increase in stability and cycle stability when the doped lithium titanate is used as anode. In particular, this is achieved by incorporating additional metal ions, preferably Al, Mg, Ga, Fe, Co, Sc, Y, Mn, Ni, Cr, V or several of these ions, into the lattice structure. Aluminium is quite particularly preferred. The doped lithium titanium spinels are also rutile-free in particularly preferred embodiments.

The doping metal ions which can sit on lattice sites of either the titanium or the lithium are preferably present in a quantity of from 0.05 to 10 wt.-%, preferably 1-3 wt.-%, relative to the total spinel.

In a further preferred embodiment of the present invention, the active material of the electrode is a doped or non-doped lithium metal phosphate or vanadate with ordered or modified olivine structure or NASICON structure and the electrode functions as cathode.

By non-doped is thus meant that pure, in particular phase-pure, lithium metal phosphate is used. The term “phase-pure” is also understood in the case of lithium metal phosphates as defined above.

The lithium transition metal phosphate or vanadate obeys the formula

LiₓN_{y}M_{1-y}ZO₄,

wherein N is a metal selected from the group Mg, Zn, Cu, Ti, Zr, Al, Ga, V, Sn, B, Nb, Ca or mixtures thereof;

M is a metal selected from the group Fe, Mn, Co, Ni, Cr, Cu, Ti, Ru or mixtures thereof;

Z is P or V

and with 0<x≦1 and 0≦y<1.

The metal M is preferably selected from the group consisting of Fe, Co, Mn or Ni, thus, where y=0, has the formulae LiFePO₄, LiCoPO₄, LiMnPO₄ or LiNiPO₄.

By a doped lithium transition metal phosphate or vanadate is meant a compound of the above-named formula in which y>0 and N represents a metal cation from the group as defined above.

Quite particularly preferably, N is selected from the group consisting of Nb, Ti, Zr, B, Mg, Ca, Zn or combinations thereof, but preferably represents Ti, B, Mg, Zn and Nb.

Typical preferred compounds are e.g. LiNb_{y}FeₓPO₄, LiMg_{y}FeₓPO₄, LiMg_{y}FeₓMn_{1-x-y}PO₄, LiZn_{y}FeₓMn_{1-x-y}PO₄, LiFeₓMn₁₋ₓPO₄, LiCo_{y}FeₓMn_{1-x-y}PO₄ with x and y<1 and x+y<1.

The doped or non-doped lithium metal phosphate or vanadate, as already stated above, thus quite particularly preferably has either an ordered or a modified olivine structure.

Lithium metal phosphates or vanadates in ordered olivine structure can be described structurally in the rhombic space group Pnma (No. 62 of the International Tables), wherein the crystallographic index of the rhombic unit cells may here be chosen such that the a-axis is the longest axis and the c-axis is the shortest axis of the unit cell Pnma, with the result that the mirror plane m of the olivine structure comes to lie perpendicular to the b-axis. The lithium ions of the lithium metal phosphate then arrange themselves in olivine structure parallel to the crystal axis [010] or perpendicular to the crystal face {010}, which is thus also the preferred direction for the one-dimensional lithium-ion conduction.

By modified olivine structure is meant that a modification takes place at either the anionic (e.g. phosphate by vanadate) and/or cationic sites in the crystal lattice, wherein the substitution takes place through aliovalent or identical charge carriers in order to make possible a better diffusion of the lithium ions and an improved electronic conductivity.

In further embodiments of the present invention, the electrode further contains a second lithium-metal-oxygen compound, different from the first, selected from doped or non-doped lithium metal oxides, lithium metal phosphates, lithium metal vanadates and mixtures thereof. Naturally, it is also possible that two, three or even more further, different lithium-metal-oxygen compounds are included. It is self-evident to a person skilled in the art that, naturally, only lithium-metal-oxygen compounds which have the same functionality (thus function either as anode material or as cathode material) can be contained in an electrode formulation.

The second lithium-metal-oxygen compound is preferably selected from doped or non-doped lithium manganese oxide, lithium cobalt oxide, lithium iron manganese phosphate, lithium manganese phosphate. The second lithium-metal-oxygen compound is of advantage in particular in specific cathode formulations and is typically present in a quantity of approximately 3-50 wt.-% relative to the first lithium-metal-oxygen compound.

The object of the present invention is further achieved by a secondary lithium-ion battery with an anode, a cathode and an electrolyte containing an electrode according to the invention.

In the secondary lithium-ion battery according to the invention, the active material of the anode is preferably doped or non-doped lithium titanate in the electrode formulation according to the invention without added conductive agent. In this embodiment, the cathode can be freely chosen.

In a further preferred secondary lithium-ion battery, the active material of the cathode is doped or non-doped lithium metal phosphate in the electrode formulation according to the invention without added conductive agent with and without the presence of the second lithium-metal-oxygen compound. In this embodiment, the anode can be freely chosen.

Quite particularly preferably, in a secondary lithium-ion battery according to the invention, the active material of the anode is doped or non-doped lithium titanate in the electrode formulation according to the invention without added conductive agent and the active material of the cathode is doped or non-doped lithium metal phosphate in the electrode formulation according to the invention without added conductive agent.

It was thus surprisingly found in the present case that electrodes with a lithium-metal-oxygen compound as active material without added conductive agent can be cycled both during charging and during discharging at high to very high rates (20 C) and in different layer thicknesses (loads). Only one small difference compared with electrodes with added conductive agent was discovered. This was found both for pure lithium-metal-oxygen compounds (produced hydrothermally and by solid-state synthesis) and for carbon-coated lithium-metal-oxygen compounds.

Without being bound to a specific theory, the explanation for the surprising finding that lithium-metal-oxygen compounds can also be used as electrode without conductive addition may be that even when there is a lengthy discharge (delithiation) the non-conductive starting state is never fully reached. This is true in particular for the class of compounds of lithium titanates.

With lithium titanates, traces of Ti³⁺ apparently still remain in the crystal lattice, whereby the material and the electrode always retain a sufficient electronic conductivity as long as the particle-particle contact remains good. The electronic conductivity is thus not a limiting factor when cycling lithium titanates.

The invention is described in more detail below with reference to the figures and embodiment examples which are not, however, to be considered limiting.

### BRIEF DESCRIPTION OF THE DRAWINGS

FIG. 1 the cycle life of a conventional lithium titanate electrode with added conductive carbon black;

FIGS. 2a to 2b the polarization of an electrode of the state of the art with active material, i.e. with added conductive carbon black as a function of the load;

FIG. 3a the specific capacity of a lithium titanate electrode according to the invention and FIG. 3b the specific capacity of an electrode of the state of the art;

FIGS. 4a and 4b the discharge (4a) and charge (4b) capacity of a lithium titanate electrode according to the invention with no fall during the discharge;

FIGS. 5a and 5b respectively the discharge (5a) and charge (5b) capacity of a lithium titanate electrode according to the invention, with a fall during the discharge;

FIGS. 6a and 6b the specific capacity of an electrode according to the invention, FIG. 6a: with a fall during the discharge, FIG. 6b: with no fall during the discharge;

FIGS. 7a to 7b the influence of the active material load on the capacity of an electrode according to the invention;

FIG. 8a the discharge capacity of an electrode according to the invention which contains carbon-coated lithium titanate particles as active material, FIG. 8b the discharge capacity of an electrode of the state of the art which contains lithium titanate coated with carbon as active material;

FIGS. 9a to 9b the charge capacity of an electrode (9a) according to the invention [compared] with an electrode (9b) of the state of the art which contain lithium titanate coated with carbon as active material;

FIGS. 10a to 10b the specific capacity of an electrode (10a) according to the invention compared with an electrode (10b) of the state of the art which contain lithium titanate coated with carbon as active material;

FIG. 11 the comparison of the charge/discharge capacity at different rates for electrodes according to the invention and electrodes of the state of the art with LiFePO₄ as active material;

FIG. 12a the specific discharge capacity at 1 C for electrodes with LiFePO₄ as active material of the state of the art and FIG. 12b, of electrodes according to the invention, the volumetric discharge capacity at 1 C for electrodes with LiFePO₄ as active material of the state of the art and of electrodes according to the invention;

FIG. 13 the comparison of the charge/discharge capacity at different rates for an electrode according to the invention and electrodes of the state of the art with LiMn_{0.56}Fe_{0.33}Zn_{0.10}P₄ as active material;

FIG. 14a the specific discharge capacity at 1 C for electrodes of the state of the art with LiMn_{0.56}Fe_{0.33}Zn_{0.10}PO₄ as active material and of electrodes according to the invention each with LiMn_{0.56}Fe_{0.33}Zn_{0.10}PO₄ as active material; FIG. 14b the volumetric discharge capacity at 1 C for electrodes of the state of the art and of electrodes according to the invention with LiMn_{0.56}Fe_{0.33}Zn_{0.10}PO₄ as active material.

FIG. 15 the volumetric capacity of electrodes according to the invention and electrodes of the state of the art with lithium titanate (both coated with carbon and uncoated) [as active material].

### DETAILED DESCRIPTION

### Embodiment Examples

The compounds lithium titanate with and without carbon coating and lithium iron phosphate with and without carbon coating are commercially available from the companies Süd-Chemie AG, Germany, and Phostech Lithium, Canada, respectively. LiMn_{0.56}Fe_{0.33}Zn_{0.10}PO₄ with and without carbon coating can be produced analogously to the methods described in the literature for the production of LiFePO₄.

### 1. Production of Electrodes

### 1.1 Electrodes of the State of the Art

A standard electrode of the state of the art contained 85% active material, 10% Super P carbon black as added conductive agent and 5 wt.-% polyvinylidene fluoride (PVdF) as binder (Solvay 21216).

### 2.1 Electrode According to the Invention

### 2.1.1. Lithium Titanate Anodes

The standard electrode formulation for the electrode according to the invention was

a) 95 wt.-% active material and 5 wt.-% PVdF binder and
b) 98 wt.-% active material and 2 wt.-% PVdF binder.

The active material was mixed, together with the binder (or, for the electrodes of the state of the art, with the added conductive agent), in N-methylpyrrolidone, applied to a pretreated (primer) aluminium foil by means of a coating knife and the N-methylpyrrolidone was evaporated at 105° C. under vacuum. The electrodes were then cut out (13 mm diameter) and compressed in an IR press with a pressure of 5 tons (3.9 tons/cm²) for 20 seconds at room temperature. The primer on the aluminium foil consisted of a thin carbon coating which improves the adhesion of the active material particularly when the active material content of the electrode is more than 85 wt.-%.

The electrodes were then dried overnight at 120° C. under vacuum and, if used as anode, assembled and electrochemically measured against lithium metal in half cells in an argon-filled glovebox.

The electrochemical measurements were carried out against lithium metal using LP30 (Merck, Darmstadt) as electrolyte (EC (ethylene carbonate):DMC (dimethyl carbonate)=1:1, 1 M LiPF₆). The test procedure was carried out in the CCCV mode, i.e. cycles with a constant current at the C/10 rate for the first, and at the C rate for the subsequent, cycles. In some cases, a constant voltage portion followed at the voltage limits (1.0 and 2.0 volt versus Li/Li⁺) until the current fell approximately to the C/50 rate, in order to complete the charge/discharge cycle.

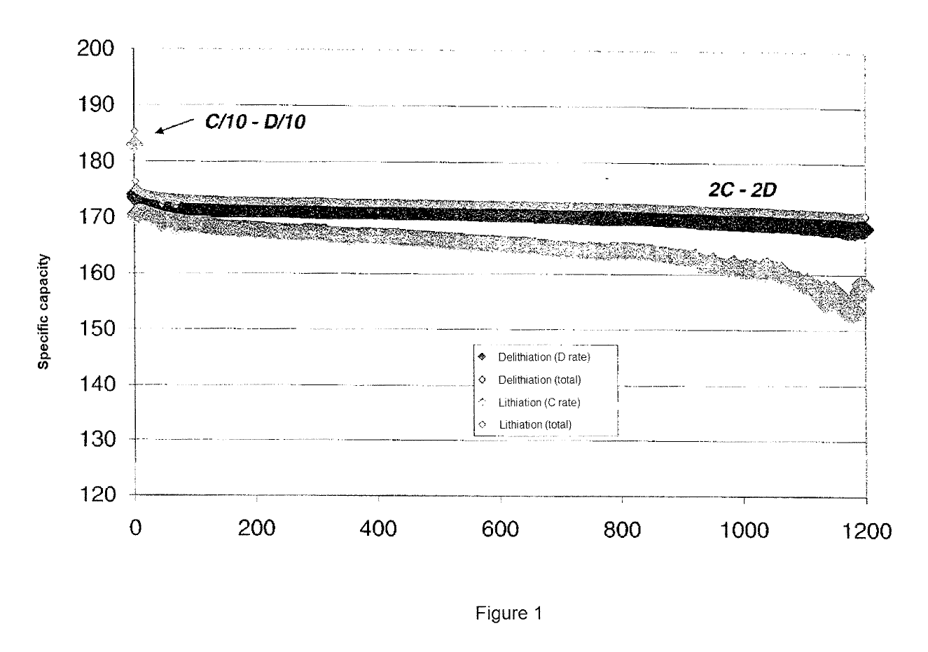

FIG. 1 shows the specific capacity, i.e. the cycle life of an electrode (anode) containing lithium titanate as active material, of the state of the art, i.e. with added conductive agent. These display a high cycle stability vis-à-vis lithium metal. Over 1000 cycles, only 2% of the total discharge capacity (delithiation) and 3.5% of the charge capacity (lithiation) were lost. The capacity obtained at 2 C displayed slightly higher losses, but were still only <6%.

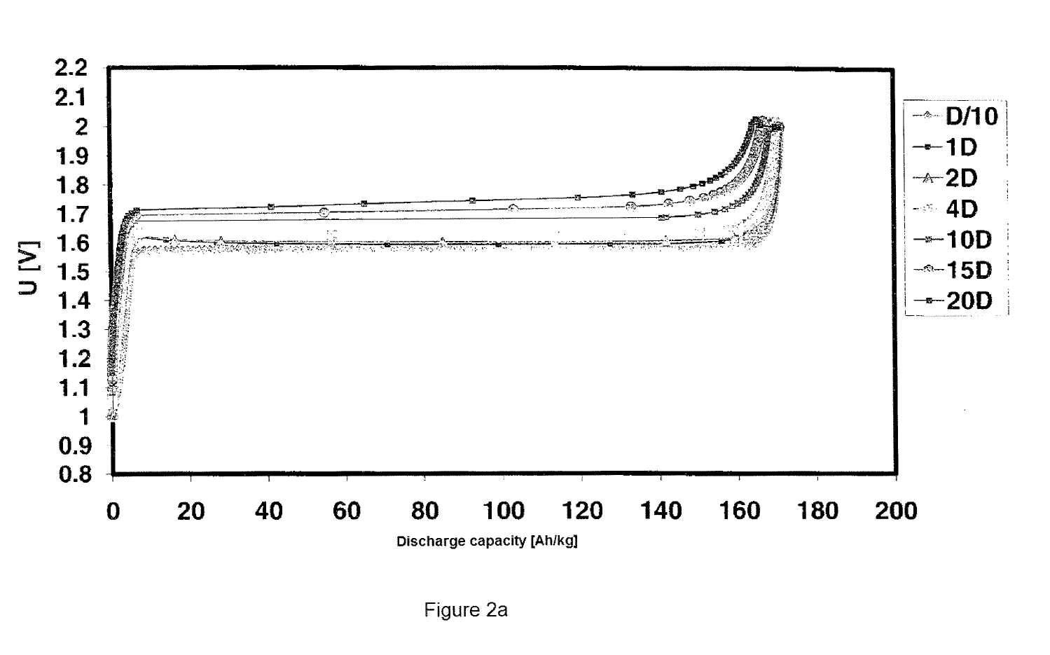

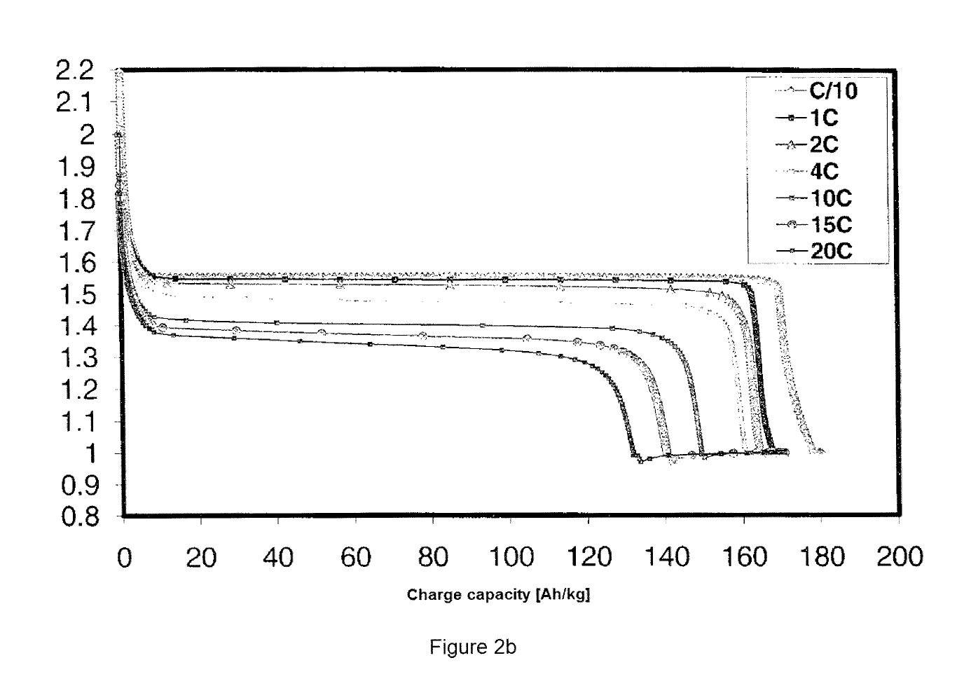

FIGS. 2a and 2b respectively show the discharge and charge capacity of a lithium titanate electrode of the state of the art. It can be seen from this that the polarization of the electrode is relatively small for the discharge, but slightly higher for the charge. The active material load was 2.54 mg/cm². With a higher load (C rate), the polarization increased, whereupon the capacity decreases, as the voltage limits are reached at an earlier stage.

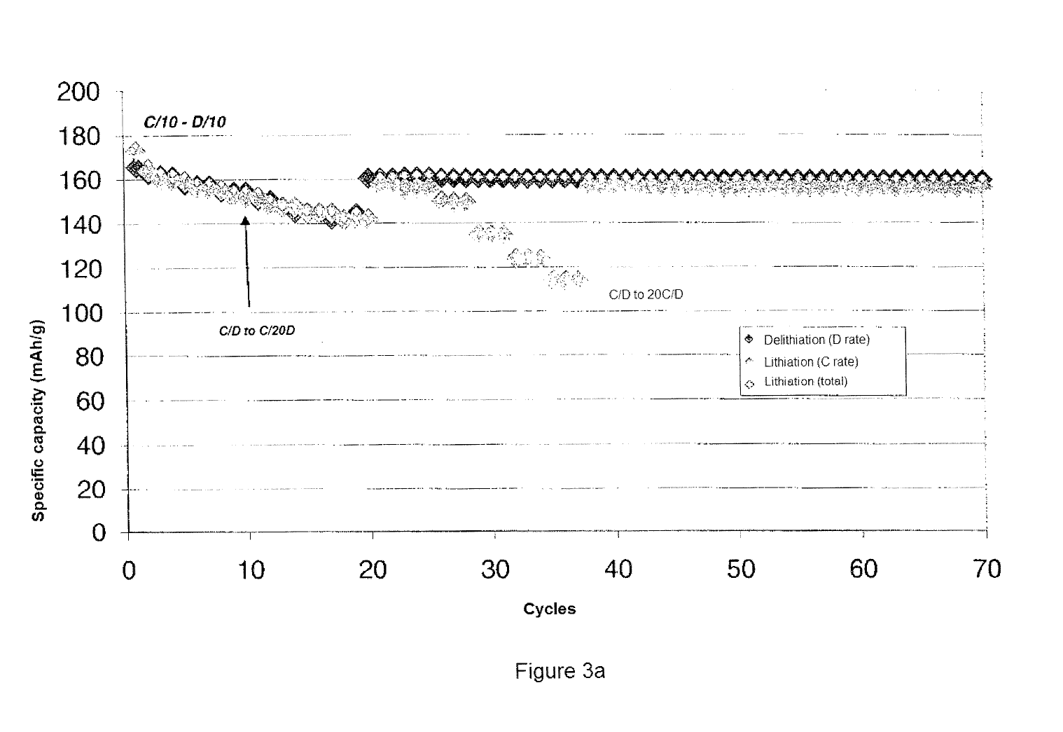

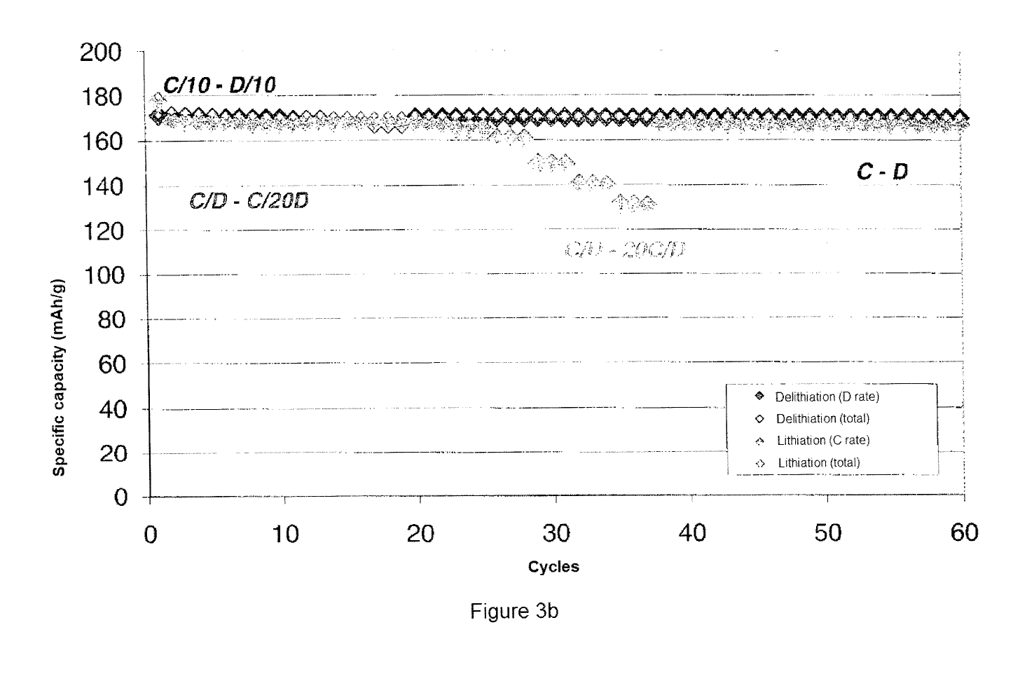

FIGS. 3a and 3b show the specific capacity of a lithium titanate electrode according to the invention (95 wt.-% active matter+5% binder), 3.4 mg load (3a) and 4.07 mg load (3b) respectively. FIG. 3a shows the specific capacity of an electrode according to the invention and FIG. 3b the specific capacity of an electrode of the state of the art with conductive carbon black.

The absence of an added conductive agent consequently produces a slightly lower specific capacity during discharge and charge cycles. However, the specific capacity is still very high.

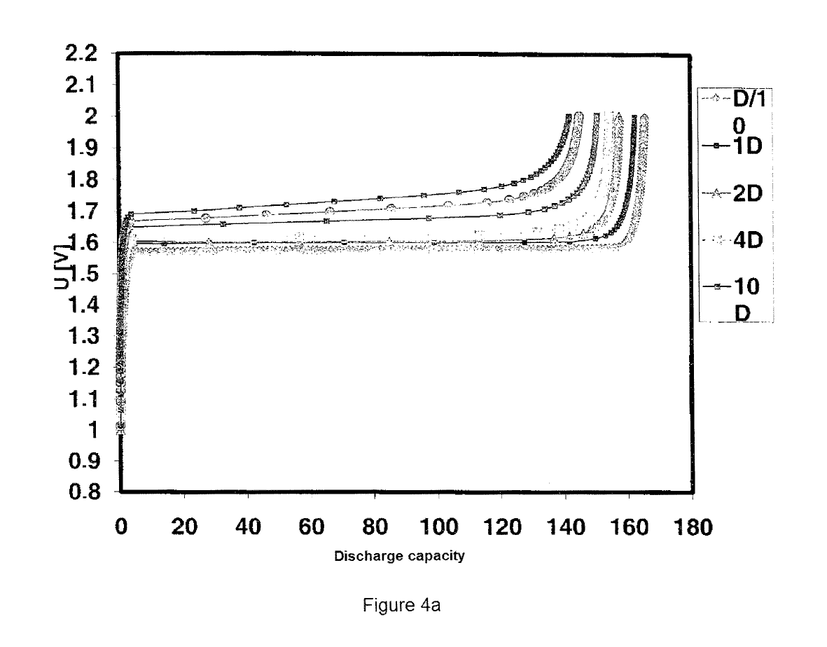

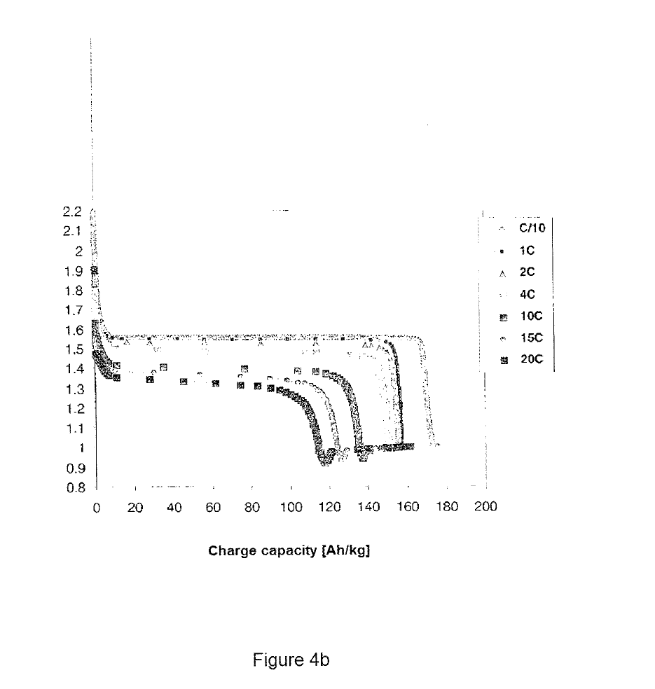

FIGS. 4a and 4b respectively show the discharge (4a) and charge (4b) capacity of an electrode according to the invention in relation to the voltage and it can be seen that, compared with an electrode with added conductive agent (FIG. 2), the polarization increased only slightly (m_{act}=2.54 mg/cm²). This means that the lithiation/delithiation reaction is only marginally influenced by the insulating chemical behaviour of the lithium titanate in its completely delithiated state. As an electronically completely insulating material cannot function as electrode, this result surprisingly means that a sufficient electronic conductivity must be present during the charge/discharge reaction. The measurements show that electronically insulating areas do not form in the electrode.

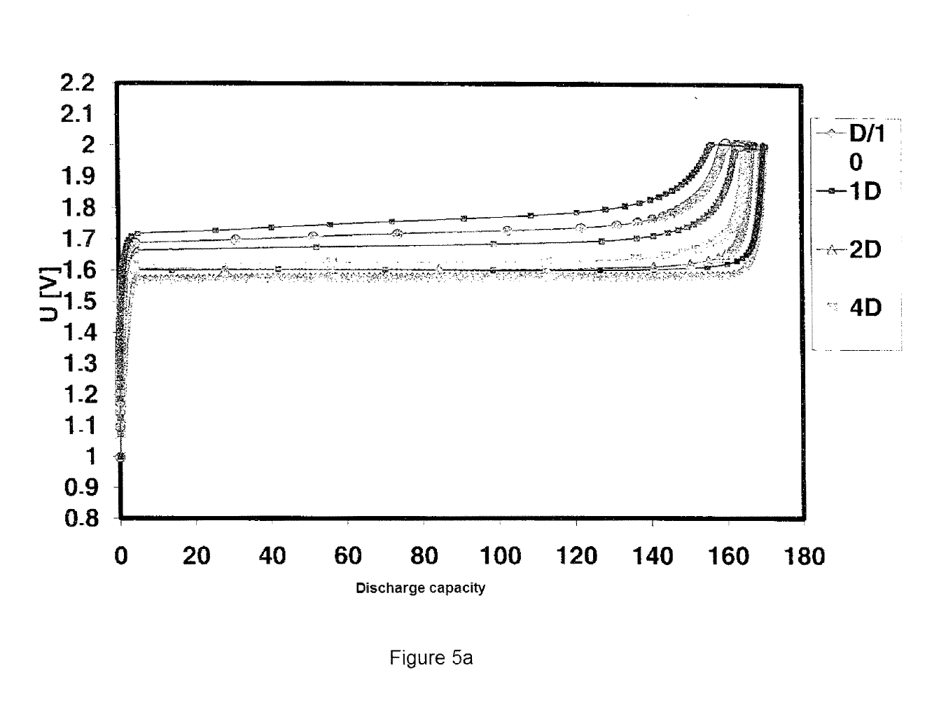

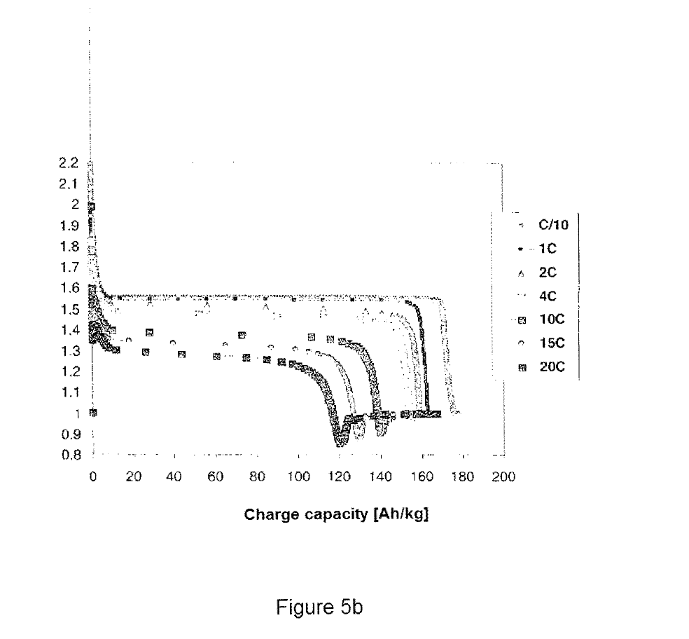

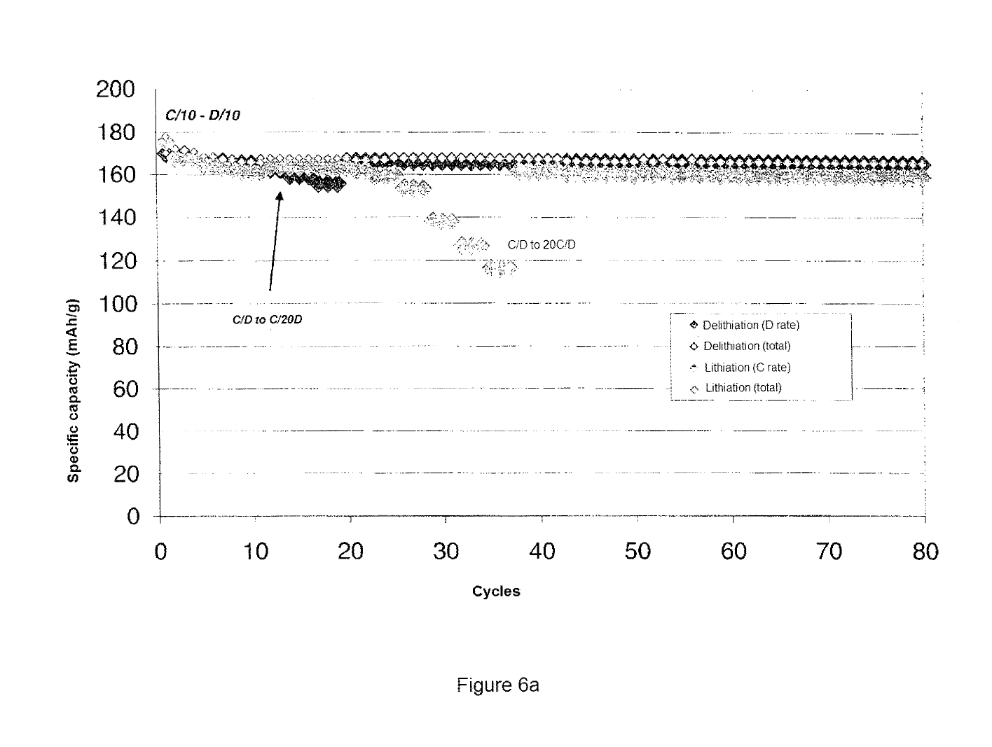

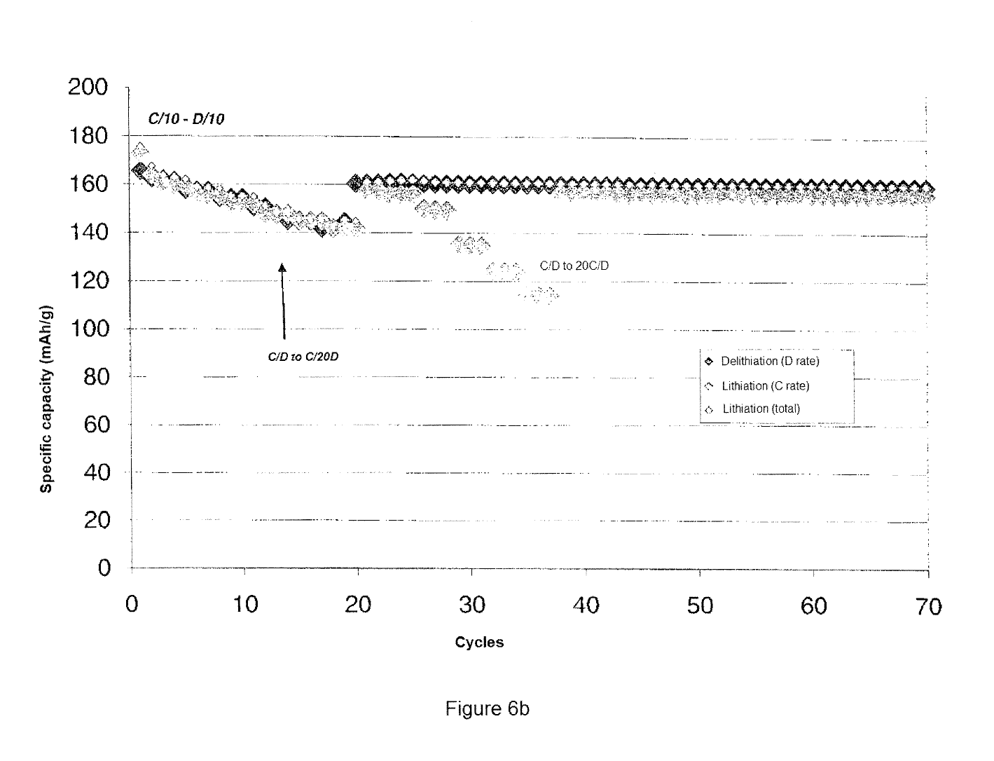

At the end of a measurement, operation at constant voltage continued for a while (CV step, “fall”); this is represented in FIG. 5 and the results are compared with those in FIG. 4. FIG. 6 compares an electrode according to the invention, with and without a fall.

In FIGS. 5a and 6a, a CV step was carried out at the end of the discharge reaction (delithiation) until the current reaches approximately C/50. A small effect of increased polarization is seen for the charge (lithiation) at rates of 10 C and more, but the effect is relatively small and was approximately 50 mV at 20 C. The active matter load is comparable to the measurements without a CV step during discharge (m_{act}=2.55 mg/cm²). This means that, even after complete delithiation of the electrode, a sufficient electronic conductivity remains in the material, which makes it possible for the material to continue to function as electrode. These measurements were carried out against lithium metal, which means that there is no limitation in respect of the counter electrode. These measurements prove that a lithium titanate anode free of added conductive agent according to the invention fulfils its function not only in a half cell but also in a full cell.

It was further found that, under both conditions, i.e. with and without a CV step at the end of the discharge, the electrodes still display a good cycle stability with a negligible reduction in capacity even after several hundred cycles. In other words, the omission of an added conductive agent therefore does not have a negative effect on the cycle stability of lithium titanate electrodes.

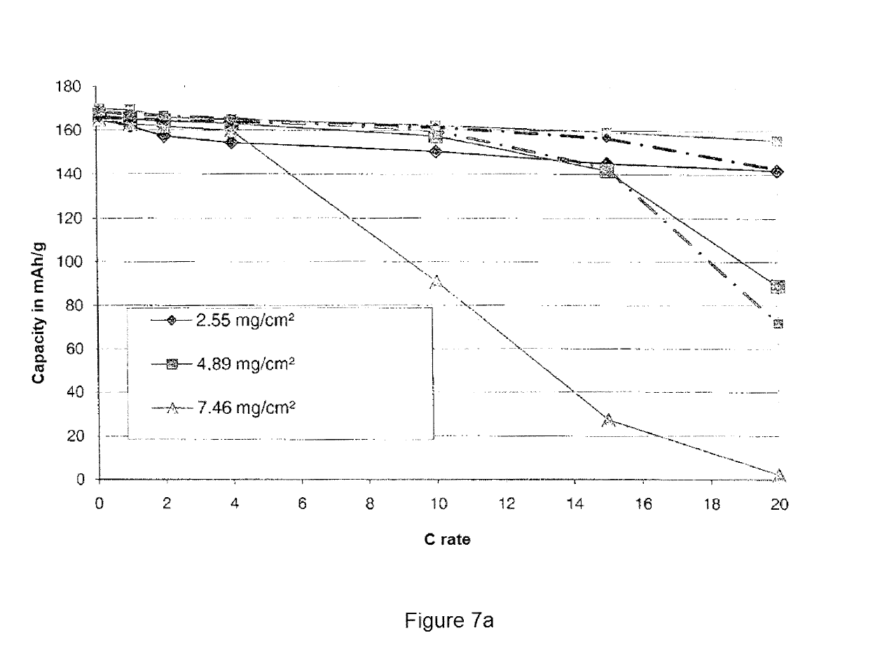

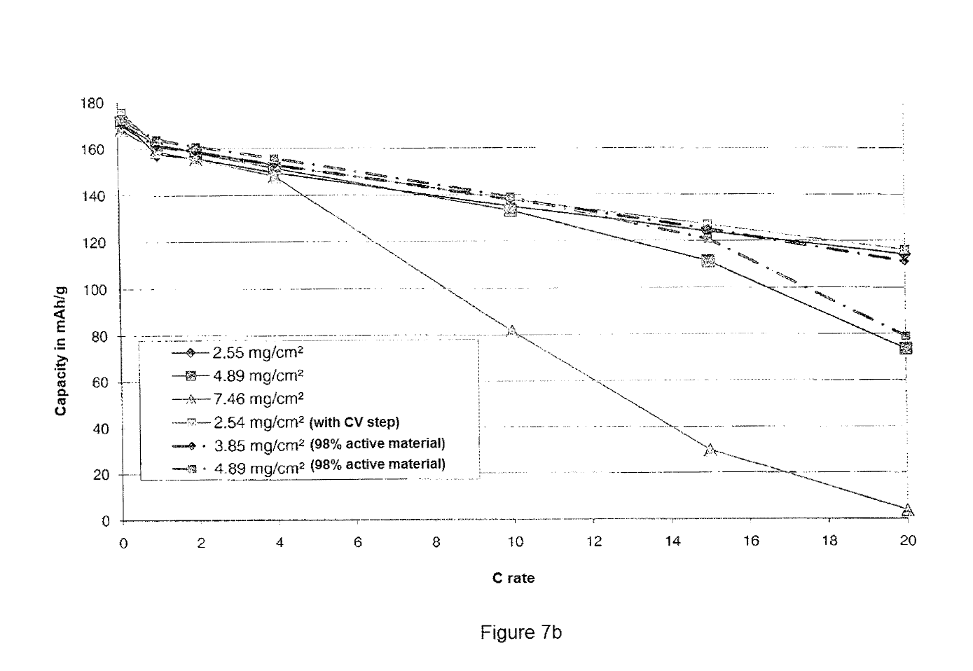

FIGS. 7a and 7b show the discharge rate (delithiation) (7a) and the charge rate (lithiation) (7b) of an electrode according to the invention with 95% active material content with different loads (in mg/cm²). Moreover, two different loads were measured for an electrode containing 98% active material and an electrode with 95% active material with an additional CV step during the discharge.

The rate capability is only slightly lower than with added conductive agent. This is particularly pronounced in particular at rates of >10 C. The delithiation reaction (discharge) is usually faster than the lithiation reaction (charge). The increase in the level of active material from 95 to 98% appears to have no effect on the rate capability. Nor does the CV step at the end of the charge influence the rate capability.

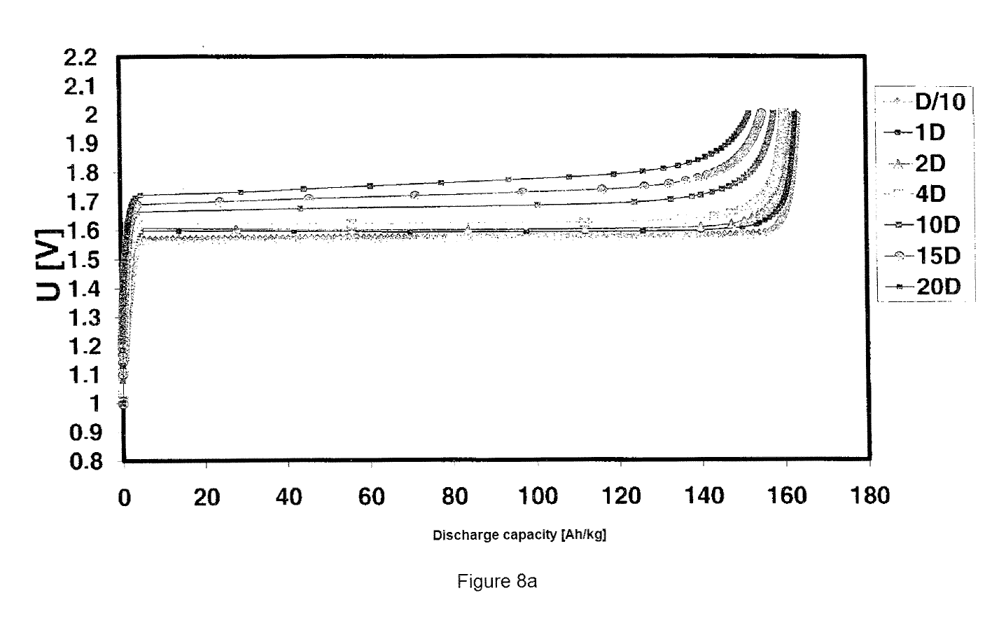

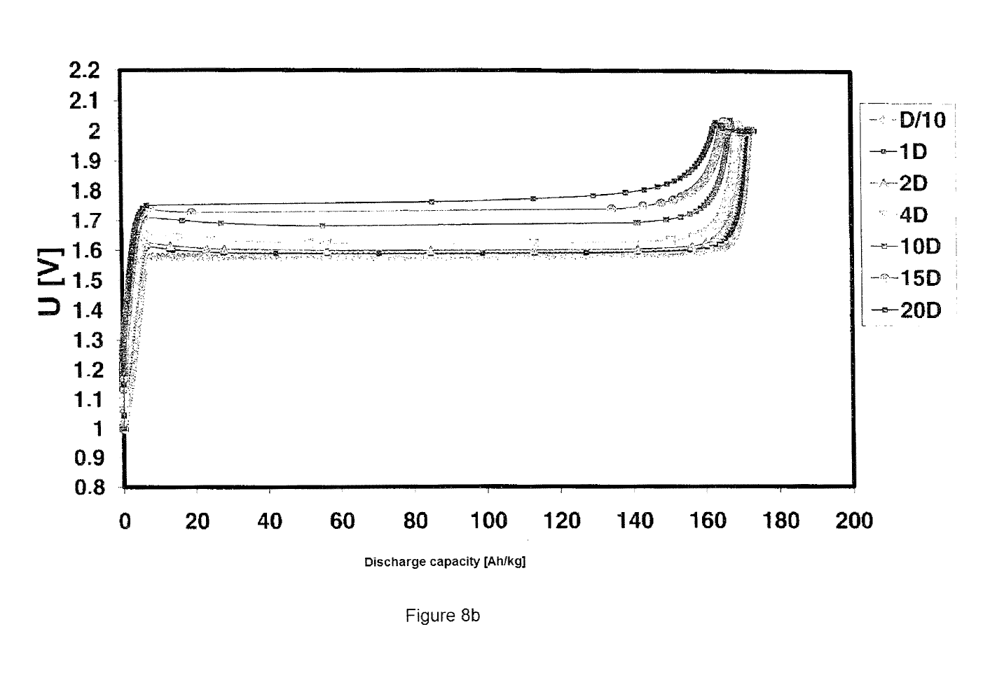

FIGS. 8a and 8b respectively show the discharge capacity of an electrode according to the invention which contains carbon-coated lithium titanate particles (FIG. 8a) compared with a customary formulation with added conductive agent (8b). FIG. 8a shows that there is no significant difference in respect of the polarization between the electrode according to the invention and the electrode of the state of the art (FIG. 8b). However, it can be seen that the end of the charge is reached earlier for the electrode according to the invention than for the electrode of the state of the art.

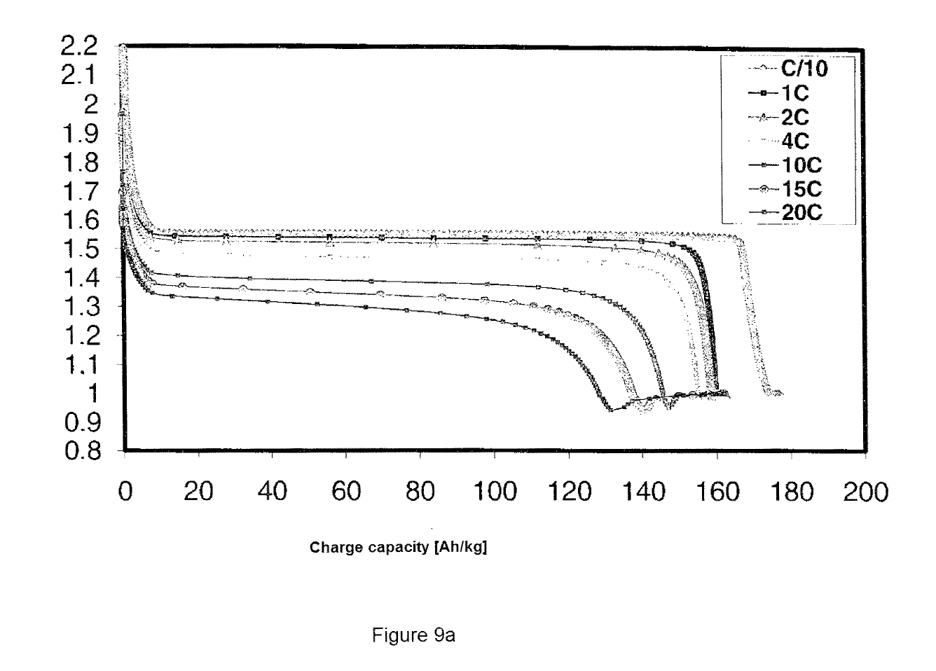

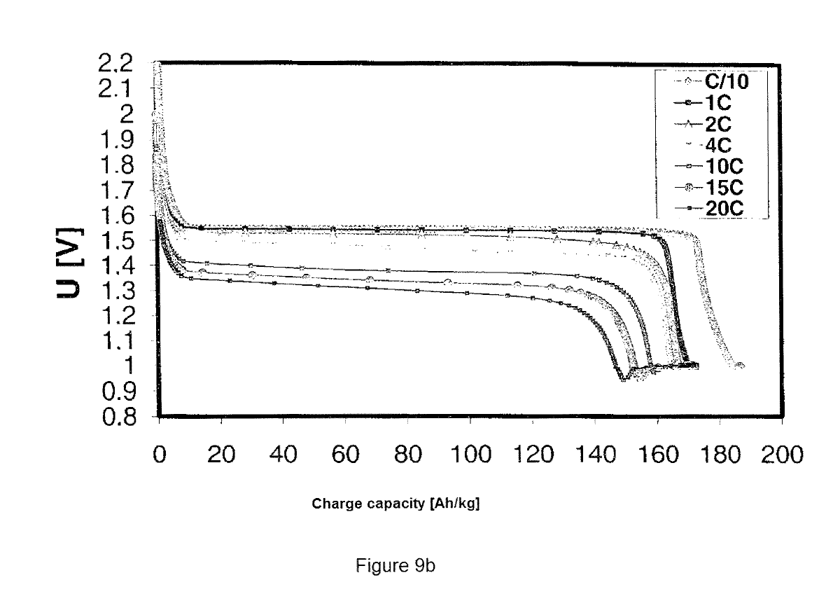

FIG. 9a shows the voltage relative to the charge capacity of an electrode according to the invention and of an electrode of the state of the art (9b) each with carbon-coated lithium titanate as active material. No significant difference in polarization was able to be determined.

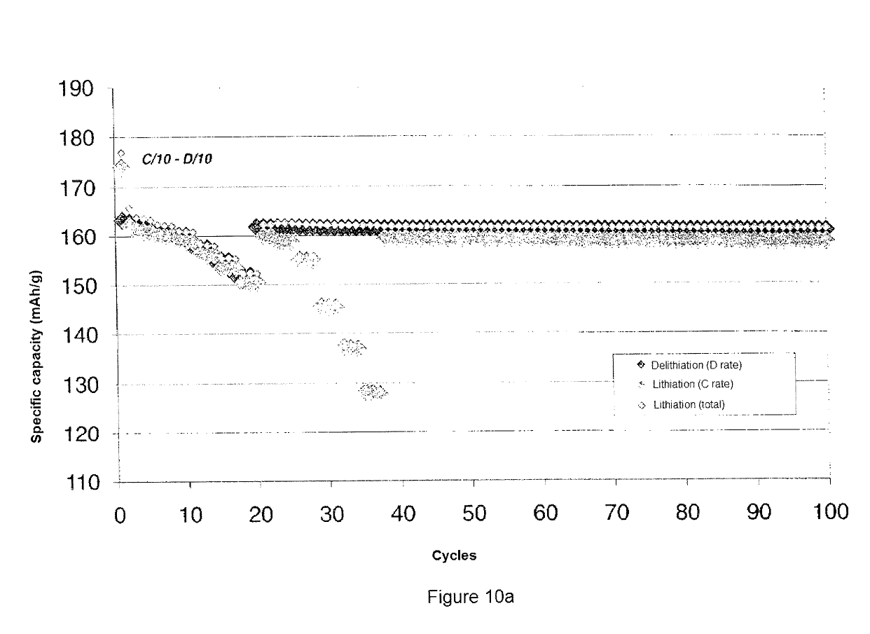

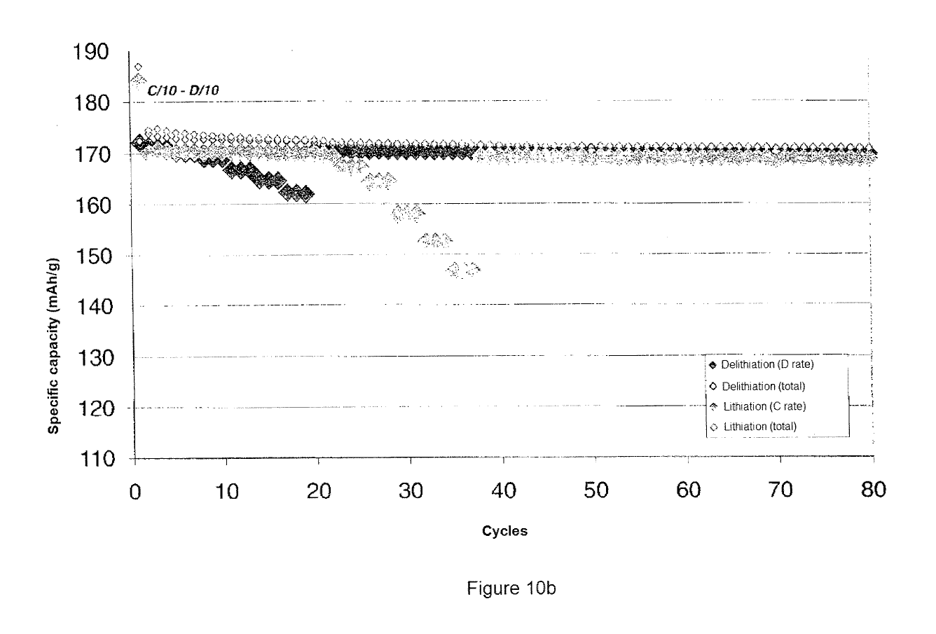

The rate capability of the formulation according to the invention is still very high and is actually better than that of the material not coated with carbon. The rate capabilities of an electrode according to the invention containing carbon-coated lithium titanate (FIG. 10a) and of an electrode of the state of the art (carbon-coated lithium titanate with added conductive agent) (FIG. 10b) are compared in FIG. 10.

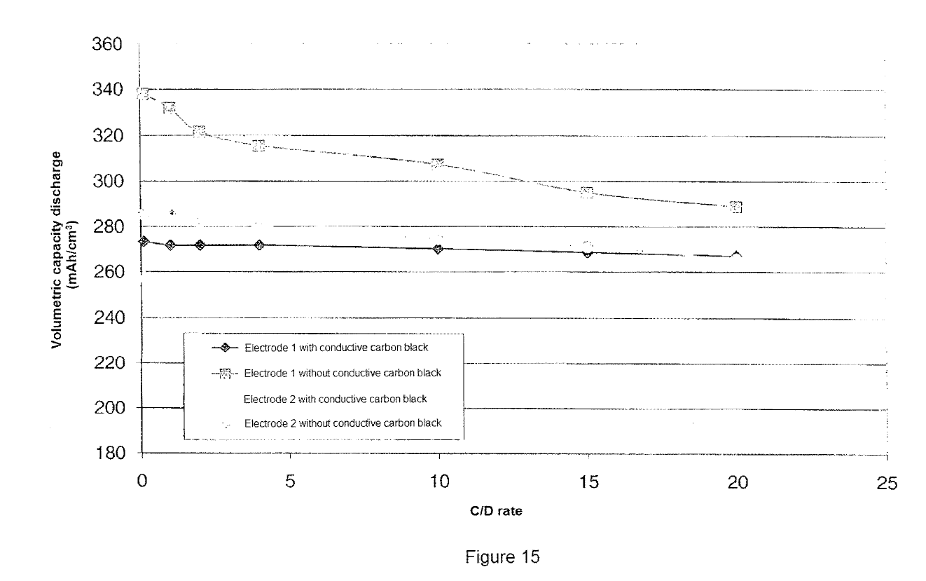

FIG. 15 shows the volumetric capacity during discharge of electrodes according to the invention and electrodes of the state of the art with lithium titanate as active material. Electrode 2 contains carbon-coated, and electrode 1 uncoated, lithium titanate as active material. It can be seen from this that the electrodes according to the invention sometimes display clearly better values than the corresponding electrodes of the state of the art.

### 2.1.2. Cathodes According to the Invention

The standard electrode formulations for cathodes according to the invention are:

a) 95 wt.-% active material and 5 wt.-% PVdF binder (LiFePO₄ cathodes)
b) 93 wt.-% active material and 7 wt.-% PVdF binder (LiMn_{0.56} Fe_{0.33}Zn_{0.10}PO₄ cathodes)

The active material was mixed, together with the binder (or, for the electrodes of the state of the art, with the added conductive agent), in N-methylpyrrolidone, applied to a pretreated (primer) aluminium foil by means of a coating knife and the N-methylpyrrolidone was evaporated at 105° C. under vacuum. The electrodes were then cut out (13 mm diameter) and roll-coated with a roller at room temperature. The starting nip width is e.g. 0.1 mm and the desired thickness progressively builds up in steps of 5-10 μm. 4 rolled coats are applied at each step and the foil is rotated by 180°. After this treatment, the thickness of the coating should be between 20 and 25 μm. The primer on the aluminium foil consisted of a thin carbon coating which improves the adhesion of the active material particularly when the active material content of the electrode is more than 85 wt.-%.

The electrochemical cells are then produced as described for lithium titanate.

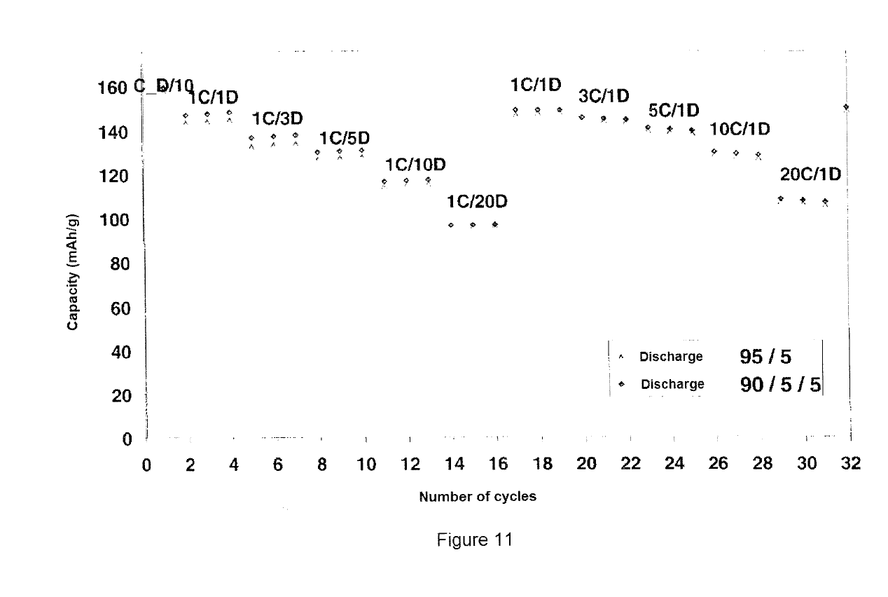

FIG. 11 shows the charge and discharge capacity of an LiFePO₄ electrode of the state of the art and of an electrode according to the invention, i.e. without added conductive agent.

The electrodes were, unlike with the above-named lithium titanate anodes, pressed four times at 10 tons for 30 seconds after applying the active matter. The electrode densities of the electrodes were respectively 2.08 g/cm³ and 2.27 g/cm³ for the electrode of the state of the art and for the electrode according to the invention.

The rate capabilities during charge and discharge reactions were measured in half cells against lithium in the range of from 2.0 to 4.1 volt. The specific capacity of both electrodes is very similar at all charge/discharge rates for these electrodes.

In addition, cyclability experiments were carried out in half cells at room temperature in the 2.0 volt to 4.0 volt range. LiFePO₄ electrodes according to the invention displayed a specific capacity at the 1 C rate. There is no difference in the stability of the specific capacity compared with electrodes of the state of the art.

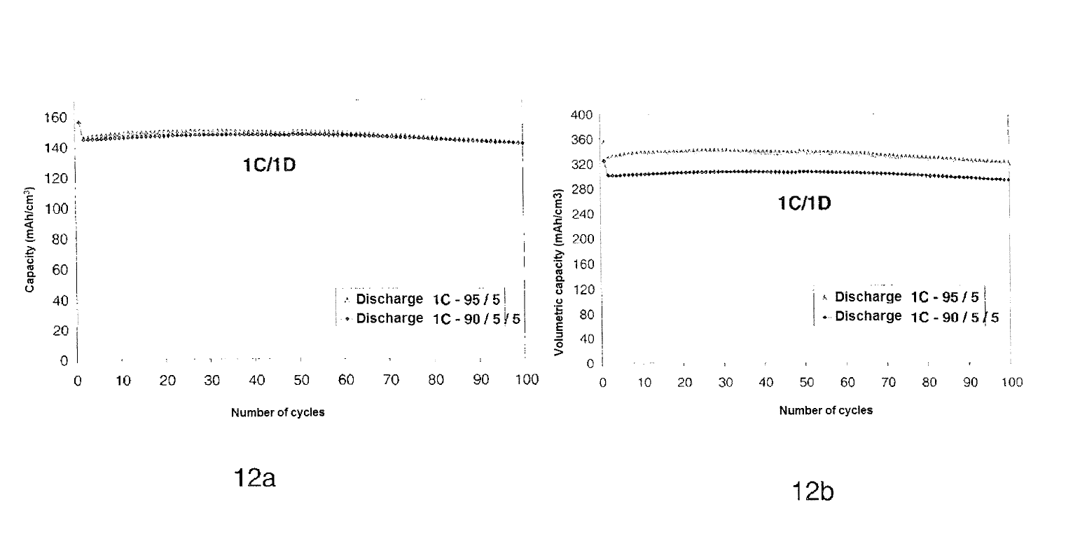

In contrast, there is an improvement in respect of the volumetric capacity of electrodes according to the invention. (FIGS. 12a and 12b)

Furthermore, electrodes of the state of the art and electrodes according to the invention with LiMn_{0.56}Fe_{0.33}Zn_{0.10}PO₄ as active material were also compared with each other:

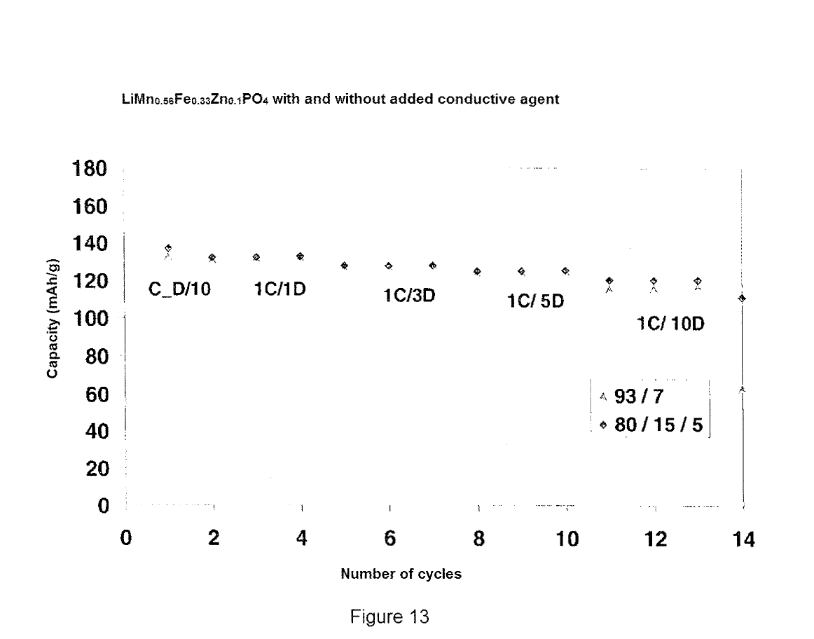

FIG. 13 shows the rate capability in an electrode of the state of the art and of the electrodes according to the invention, and an excellent relative discharge rate was found for the electrodes according to the invention.

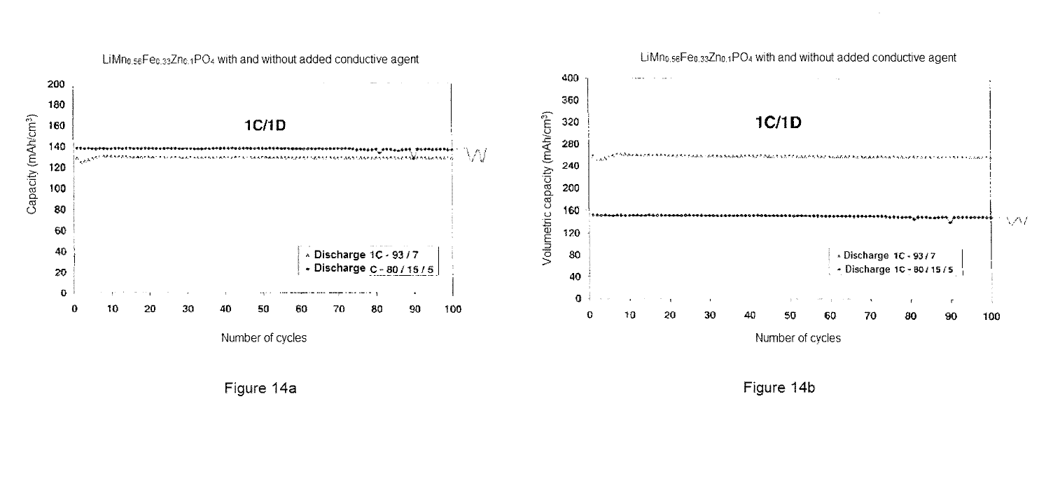

LiMn_{0.56}Fe_{0.33}Zn_{0.10}PO₄ electrodes according to the invention displayed an excellent cycle stability at 1 C/1 D. No difference in the stability compared with electrodes according to the invention containing the same active material is observed. However, the electrodes according to the invention have an improved volumetric capacity (FIGS. 14a and 14b).

1. Electrode, free of added conductive agent, with a lithium-metal-oxygen compound as active material.

2. Electrode according to claim 1, further containing a binder.

3. Electrode according to claim 2 with a proportion of the active material of ≧94 wt.-%.

4. Electrode according to claim 3, wherein the active material is selected from the group consisting of doped or non-doped lithium titanates, lithium metal phosphates, and lithium metal vanadates.

5. Electrode according to claim 4, wherein particles of the active material have a carbon coating.

6. Electrode according to claim 4, wherein the active material is a doped or non-doped lithium titanate.

7. Electrode according to claim 4, wherein the active material is a doped or non-doped lithium metal phosphate.

8. Electrode according to claim 7, wherein the doped or non-doped lithium metal phosphate has an ordered or modified olivine structure.

9. Electrode according to claim 8 with a doped or non-doped lithium metal phosphate of the formula
LiₓN_{y}M_{1-y}PO₄,
wherein N is a metal selected from the group Mg, Zn, Cu, Ti, Zr, Al, Ga, V, Sn, B or mixtures thereof;
M is a metal selected from the group Fe, Mn, Co, Ni, Cr, Cu, Ti, Ru;
and with 0<x≦1 and 0≦y<1.

10. Electrode according to claim 7, further containing a second lithium-metal-oxygen compound, different from the first, selected from the group consisting of doped or non-doped lithium metal oxides, lithium metal phosphates, lithium metal vanadates, and mixtures thereof.

11. Electrode according to claim 10, wherein the second lithium-metal-oxygen compound is selected from the group consisting of doped or non-doped lithium manganese oxide, lithium cobalt oxide, lithium iron manganese phosphate, and lithium manganese phosphate.

12. Secondary lithium-ion battery with an anode, a cathode and an electrolyte containing an electrode according to claim 1.

13. Secondary lithium-ion battery according to claim 12 with doped or non-doped lithium titanate as active material of the anode.

14. Secondary lithium-ion battery according to claim 12 with doped or non-doped lithium metal phosphate as an active material of the cathode.
